(19) United States
(12) Patent Application Publication
(10) Pub. No.: US 2005/0267240 A1
(43) Pub. Date: Dec. 1, 2005

(54) Moisture resistant highly-neutralized ethylene copolymers and their use in golf balls

(76) Inventor: John Chu Chen, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/201,893

(22) Filed: Aug. 11, 2005

Related U.S. Application Data
(63) Continuation-in-part of application No. 10/269,341, filed on Oct. 11, 2002, now Pat. No. 6,953,820.
Application No. 10/269,341 is a continuation-in-part of application No. 09/691,284, filed on Oct. 18, 2000, now Pat. No. 6,653,382.
Application No. 09/691,284 is a continuation-in-part of application No. 09/558,894, filed on Apr. 27, 2000, now Pat. No. 6,777,472.
Application No. 09/558,894 is a continuation-in-part of application No. 09/422,142, filed on Oct. 21, 1999, now abandoned.

(51) Int. Cl. C08L 33/02; C08L 1/00

(52) U.S. Cl. 524/322; 525/221

(57) ABSTRACT

The present invention describes thermoplastic compositions having high resilience (high coefficient of restitution) and low moisture sensitivity, and their use as golf ball components. Melt-processible, highly-neutralized ethylene acid copolymers and process for making them by incorporating an aliphatic, mono-functional organic acid in the acid copolymer and then neutralizing greater than 70% of all the acid groups present. Such compositions comprising at least 50% Zn and/or Ca as counterions for the salts exhibit surprising resistance to moisture absorption.

This application is a continuation-in-part of U.S. patent application Ser. No.10/269,341, which is a continuation-in-part of U.S. patent application Ser. No. 09/691,284 which is now issued as U.S. Pat. No. 6,653,382, and which is a continuation-in-part of U.S. application Ser. No. 09/558,894, now issued as U.S. Pat. No. 6,777,472 and which claims priority to U.S. patent application Ser. No. 09/422,142, now abandoned.

### BACKGROUND OF THE INVENTION

1. Field of the Invention

The invention relates to melt-processible, highly-neutralized ethylene, C₃ to C₈ α,β ethylenically unsaturated carboxylic acid thermoplastic copolymers and process for making them. It particularly relates to such copolymers that are neutralized to greater than 70%.

Even more particularly this invention relates to such thermoplastic copolymers used for making molded golf ball components.

2. Description of Related Art

Typical premium golf balls include three-piece balls, two-piece balls and multi-layered balls. “Three-piece” balls typically have a spherical molded center, elastomeric thread-like material wound around the center, and either a thermoplastic or thermoset cover. “Two-piece” balls typically have a spherical molded core covered with a thermoplastic material. “Multi-layered” balls typically have a spherical molded core and one or more intermediate layers or mantles between the core and a cover.

Three-piece centers and two-piece and multi-layer cores have traditionally been made using a thermoset rubber such as polybutadiene rubber. With thermoset rubber, complex multi-step processes are needed to make cores and centers and scrap difficult to be recycled. Attempts to solve these difficulties by substituting a thermoplastic for the thermoset have had limited success. Also, attempts to make premium one-piece balls have been unsuccessful. See U.S. Pat. No. 5,155,157, UK Patent Application 2,164,342A and WO 92/12206. Balls, cores and centers made based on these references have a high cost and lack properties such as durability, softness (low Atti compression), and resilience to make them useful in premium balls.

One thermoplastic that has found utility in golf ball components and other applications for a long time are ionomers of copolymers of alpha olefins, particularly ethylene, and C₃₋₈ α,β ethylenically unsaturated carboxylic acid. U.S. Pat. No. 3,264,272 (Rees) teaches methods for making such ionomers from “direct” acid copolymers. “Direct” copolymers are polymers polymerized by adding all monomers simultaneously, as distinct from a graft copolymer, where another monomer is grafted onto an existing polymer, often by a subsequent free radical reaction. A process for preparing the acid copolymers on which the ionomers are based is described in U.S. Pat. No. 4,351,931.

The acid copolymers may contain a third “softening” monomer that disrupts the crystallinity of the polymer. These acid copolymers, when the alpha olefin is ethylene, can be described as an E/X/Y copolymers wherein E is ethylene, X is the α,β ethylenically unsaturated carboxylic acid, particularly acylic and methacrylic acid, and Y is the softening co-monomer. Preferred softening co-monomers are C₁ to C₈ alkyl acrylate or methacrylate esters. X and Y can be present in a wide range of percentages, X typically 0.1-35 weight percent (wt %) of the polymer and Y typically 0-50 weight percent of the polymer.

A wide range of cations is known for neutralizing acid moieties in the acid copolymer. The degree of neutralization is known to vary over a wide range. Typical cations include lithium, sodium, potassium, magnesium, calcium, barium, lead, tin, zinc, aluminum, and combinations of such cations. Neutralization to 90% and higher, including up to 100%, is known, but such a high degree of neutralization results in a loss of melt-processibility or properties such as elongation and toughness. This is particularly so for copolymers with high acid levels.

Highly neutralized acid copolymer compositions that are modified by the inclusion of organic acids increases the ionic content and hence can have a tendency to pick up moisture when exposed to atmospheric moisture for prolonged periods. In golf ball applications, this moisture sensitivity property limits the viability of practical use of such compositions to parts of a golf ball due to the associated weight gain and/or property variations. Alternatively, such acid copolymer compositions need to be protected by a moisture barrier in the golf ball construction to prevent the direct exposure to the atmospheric moisture or water.

A golf ball core that comprises a composition that is susceptible to moisture absorption can be particularly problematical. Such a core could pick up a substantial amount of water since the core accounts for the major weight percentage of a golf ball. Moisture absorption by a core can result in the ball acquiring so much water that the ball becomes illegal because of the weight standards.

It can be desirable to provide a thermoplastic acid copolymer composition that can be used in a golf ball part without the need for also including a protective barrier against moisture to prevent moisture absorption by the acid copolymer portion of the golf ball. Furthermore, it is desirable to provide a high performance material with moisture barrier property to be used in the golf ball construction to protect other parts of the golf ball which are prone to moisture pick up, such as the TS robber core, etc.

### SUMMARY OF THE INVENTION

A thermoplastic composition comprising (a) at least one aliphatic, mono-functional organic acid having fewer than 36 carbon atoms; and (b) ethylene, C₃ to C₈ α,β ethylenically unsaturated carboxylic acid copolymer(s) and ionomer(s) thereof, wherein greater than 70 mol % of all the acid of (a) and (b) are neutralized to salts and wherein at least about 50 mol % of the acid salts comprise Zn and/or Ca counterions.

A golf ball comprising a thermoplastic composition comprising (a) aliphatic, mono-functional organic acid(s) having fewer than 36 carbon atoms; and (b) ethylene, C₃ to C₈ α,β ethylenically unsaturated carboxylic acid copolymer(s) and ionomer(s) thereof, wherein greater than 70 mol % of all the acid of (a) and (b) are neutralized to salts and wherein at least about 50 mol % of the acid salts comprise Zn and/or Ca counterions.

A golf ball comprising a cover comprising a thermoplastic or thermoset polymer, such as polyurethane, polyether-ester, polyether-urea, polyether-amide, block copolymers of styrene and butadiene, and at least one intermediate layer and/or core that comprises a thermoplastic composition comprising (a) aliphatic, mono-functional organic acid(s) having fewer than 36 carbon atoms; and (b) ethylene, C₃ to C₈ α,β ethylenically unsaturated carboxylic acid copolymer(s) and ionomer(s) thereof, wherein greater than 70 mol % of all the acid of (a) and (b) are neutralized to salts and wherein at least about 50 mol % of the acid salts comprise Zn and/or Ca counterions.

### DETAILED DESCRIPTION OF THE INVENTION

In this disclosure, the term “copolymer” is used to refer to polymers containing two or more monomers. The phrase “copolymer of various monomers” means a copolymer whose units are derived from the various monomers. “Consisting essentially of” means that the recited components are essential, while smaller amounts of other components may be present to the extent that they do not detract from the operability of the present invention. The term “(meth) acrylic acid” means methacrylic acid and/or acrylic acid. Likewise, the term “(meth) acrylate” means methacrylate and/or acrylate.

All references identified throughout this Specification including those in the Description of Related Art and those to which this case claims priority are incorporated by reference as if fully set forth herein.

Acid Copolymers

The acid copolymers used in the present invention to make the ionomers are preferably ‘direct’ acid copolymers. They are preferably alpha olefin, particularly ethylene, C₃₋₈ α,β ethylenically unsaturated carboxylic acid, particularly acrylic and methacrylic acid, copolymers. They may optionally contain a third softening monomer. By “softening”, it is meant that the crystallinity is disrupted (the polymer is made less crystalline). Suitable “softening” comonomers are monomers selected from alkyl acrylate, and alkyl methacrylate, wherein the alkyl groups have from 1-8 carbon atoms.

The acid copolymers, when the alpha olefin is ethylene, can be described as E/X/Y copolymers where E is ethylene, X is the α,β ethylenically unsaturated carboxylic acid, and Y is a softening comonomer. X is preferably present in an amount of from about 3 to about 30 wt %, preferably from about 4 to about 25 wt %, more preferably from about 5 to about 20 wt % of the polymer, and Y is preferably present in an amount of from about 0 to about 50 wt %, alternatively from about 0 to about 40 wt %, or from about 5 to about 35 wt %, or from about 10 to about 35 wt %, or from about 15 to about 30 wt % of the polymer.

The ethylene-acid copolymers with high levels of acid (X) are difficult to prepare in continuous polymerizers because of monomer-polymer phase separation. This difficulty can be avoided however by use of “co-solvent technology” as described in U.S. Pat. No. 5,028,674 or by employing somewhat higher pressures than those at which copolymers with lower acid can be prepared.

Specific acid-copolymers include ethylene/(meth) acrylic acid copolymers. They also include ethylene/(meth) acrylic acid/n-butyl (meth) acrylate, ethylene/(meth) acrylic acid/iso-butyl (meth) acrylate, ethylene/(meth) acrylic acid/methyl (meth) acrylate, and ethylene/(meth) acrylic acid/ethyl (meth) acrylate terpolymers.

Ionomer

The unmodified, melt processible ionomers used in this invention are prepared from acid copolymers by methods known in the art of preparing ionomers. By “unmodified”, it is meant that the ionomers are not blended with any material that has been added for the purpose of modifying the properties of the unblended ionomer. They include partially neutralized acid copolymers, particularly ethylene/(meth) acrylic acid copolymers. The unmodified ionomers may be neutralized to any level that does not result in an intractable (not melt processible) polymer that does not have useful physical properties. Preferably, about 15 to about 90%, preferably about 50 to about 75% of the acid moiety of the acid copolymer is neutralized by an alkali metal, an alkaline earth metal, or a transition metal cation. For acid copolymers having a high acid level (for example over 15 wt %), the percent neutralization must be lower to retain melt processibility.

Cations useful in making the unmodified ionomers useful in the practice of the present invention are lithium, sodium, potassium, magnesium, calcium, or zinc, or a combination of such cations. In the practice of the present invention calcium and zinc ionomers are particularly preferred. While other cations can be present in the blended composition, the equivalent percentage of calcium and/or zinc salts in the final blended ionomeric composition must be at least about 50 mol equivalent %, preferably at least about 60 equivalent %, more preferably at least about 70 equivalent %, even more preferably at least about 80%, and most preferably at least about 90% based on the total salts present in the blended composition. The equivalent % is determined by multiplying the mol % of the cation by the valence of the cation. The presence of CA and/or Zn cations in the preferred ranges provides moisture resistance to a component comprising such a composition.

Organic Acids and Salts

The organic acids employed in the present invention are aliphatic, mono-functional (saturated, unsaturated, or multi-unsaturated) organic acids, particularly those having fewer than 36 carbon atoms. Also salts of these organic acids may be employed. The salts may be any of a wide variety, particularly including the barium, lithium, sodium, zinc, bismuth, potassium, strontium, magnesium or calcium salts of the organic acids, with the caveat that the equivalent percentage of calcium (Ca) and/or zinc (Zn) salts in the final blended ionomeric composition must be at least about 50 equivalent %, preferably at least about 60 equivalent %, more preferably at least about 70 equivalent %, even more preferably at least 80 equivalent %, and most preferably at least 90 equivalent % based on the total salts present in the blended composition.

While it may be useful for the organic acids (and salts) to have a low volatility when being melt-blended with acid copolymer or ionomer, volatility has been found to not be limiting when neutralizing the blend to high levels, particularly near to or at 100%. At 100% neutralization (all acid in copolymer and organic acid neutralized), volatility simply is no longer an issue. As such, organic acids with lower carbon content can be used. It is preferred, however, that the organic acid (or salt) be non-volatile and non-migratory. It is preferred that they are agents that effectively plasticize ionic arrays and/or remove ethylene crystallinity from an ethylene, C₃₋₈ α,β ethylenically unsaturated carboxylic acid copolymers or ionomers thereof. By non-volatile, it is meant that they do not volatilize at temperatures of melt blending with the agent with the acid copolymer. By non-migratory, it is meant that the agent does not bloom to the surface of the polymer under normal storage conditions (ambient temperatures. Particularly useful organic acids include C₄ to less than C₃₆ (say C₃₄), C₆ to C₂₆, particularly C₆ to C₂₂, particularly C₁₂ to C₂₂, organic acids. Particular organic acids useful in the present invention include caproic acid, caprylic acid, capric acid, lauric acid, stearic acid, behenic acid, erucic acid, oleic acid, and linoelic acid.

Filler

The optional filler component of the subject invention is chosen to impart additional density to blends of the previously described components, the selection being dependent upon the type of golf ball desired (i.e., one-piece, two-piece, three-piece or intermediate layer), as will be more fully detailed below. Generally, the filler will be inorganic having a density greater than about 4 grams/cubic centimeter (gm/cc), preferably greater than 5 gm/cc, and will be present in amounts between 0 and about 60 wt % based on the total weight of the composition. Examples of useful fillers include zinc oxide, barium sulfate, lead silicate and tungsten carbide, tin oxide, as well as the other well known corresponding salts and oxides thereof. It is preferred that the filler materials be non-reactive or almost non-reactive.

Other Components

Additional optional additives useful in the practice of the subject invention can include: acid copolymer waxes, such as for example Honeywell wax AC540; Ti0₂, which is used as a whitening agent; optical brighteners; surfactants; processing aids; antioxidants such as, for example, Irganox 1010; UV stabilizers; and other components known in the art of golf ball manufacture to be useful but not critical to golf ball performance and/or acceptance.

Moisture Resistant (MR) High COR Thermoplastic

The present invention relates to a thermoplastic polymer that is moisture resistant and highly resilient (that is, as demonstrated by high COR values as determined by the method COR determination method (COR Method) following). A thermoplastic polymer of the present invention, when formed into a sphere that is 1.50 to 1.54 inches in diameter, has a coefficient of restitution of at least 0.740, which is measured by firing the sphere at an initial velocity of 125 feet/second against a steel plate positioned 3 feet from the point where initial velocity is determined and dividing the velocity of rebound from the plate by the initial velocity. More specifically, the invention is moisture resistant composition that provides COR measurements in the range of from about 0.740 to about 0.875 when measured according to the COR Method described hereinabove. Any COR value within the prescribed range can be considered as “high COR, and any specific point within the range is considered as within the scope of the present invention even if said point is not specifically described herein.

For the purposes of the present invention, moisture resistant shall mean a golf ball composition according to the present invention having a moisture vapor transmission rate (MVTR) of less than 100 mil-gm/m²-day, preferably less than 80, more preferably less than 50. Alternatively, moisture resistant shall mean a golf ball composition according to the present invention having a weight gain of less than 1.3 wt %, preferably less than 1.2 wt %, more preferably less than 1.0 wt %, and most preferably less than 0.8%, after exposure to an atmosphere of 50% RH (relative humidity) for 30 days at room temperature (RT).

These moisture resistant, high COR thermoplastic materials preferably are compositions that are melt blended polymers of (a) the acid copolymers or the melt processible ionomers as described above and (b) one or more aliphatic, mono-functional organic acids or salts thereof as described above, wherein greater than about 70% of all the acid of (a) and of (b) is neutralized. Preferably, greater than about 80%, more preferably greater than about 90%, and even more preferably nearly 100% of all the acid or 100% of all the acid of (a) and (b) is neutralized by a cation source.

Preferably, the acid copolymers are E/X/Y copolymers where E is ethylene, X is the α,β ethylenically unsaturated carboxylic acid, and Y is a softening comonomer. X is preferably present in an amount of from about 3 to about 30 wt % (preferably from about 4 to about 25, most preferably from about 5 to about 20) wt % of the polymer, and Y is present in an amount of from about 0 to about 50 wt % (alternatively from about 0 to about 40 wt %, or from about 5 to about 35 wt %, or from about 10 to about 30 wt % ) of the polymer. The organic acid preferably is one that is non-volatile, non-migratory and effectively plasticizes ionic arrays and/or suppresses crystallinity in the E/X/Y copolymer or ionomer.

For softer compositions, the crystallinity of the acid copolymer is disrupted by inclusion of a softening monomer or other means. Preferably, the organic acid is melt blended with this acid copolymer and either concurrent to blending or subsequent to blending the acid copolymer blend is highly neutralized to a level of greater than or equal to about 70% neutralization, preferably greater than or equal to about 80%, more preferably greater than or equal to about 90%, even more preferably to nearly 100%, or to 100% of all acid in the blend.

Selection of Materials for Resilience and Compression

The specific combinations of resilience and compression used in the practice of the subject invention will in large part be dependent upon the type of golf ball desired (i.e., one-piece, two-piece, three-piece, or multi-layered), and in the type of performance desired for the resulting golf ball as detailed below.

Three-Piece Golf Ball Preferred Embodiments

Three-piece balls are manufactured by well known techniques as described in, e.g., U.S. Pat. No. 4,846,910. For purposes of this invention, the center of these three-piece balls is made by injection or compression molding a sphere of desired size from the moisture resistant, high COR thermoplastic composition of the present invention that is optionally filled with sufficient filler to provide a desired center density depending on the diameter of the center, the windings, and the thickness and composition of the cover to produce a golf ball meeting the weight limits (45 grams) set by the PGA.

Two-Piece Golf Ball Preferred Embodiments

Two-piece balls are manufactured by well-known techniques wherein covers are injection or compression molded over cores. For purposes of this invention, the core of these two-piece balls is made by injection or compression molding a sphere of desired size from the moisture resistant, high COR thermoplastic composition of the present invention that is filled with sufficient filler to provide a desired core density. Desirable core density can be, for example, from about 1.14 gm/cc to about 1.2 gm/cc, depending on the diameter of the core and the thickness and composition of the cover to produce a golf ball meeting the weight limits (45 grams) set by the PGA.

Multi-Layer Golf Ball Preferred Embodiments

Multi-layer balls are manufactured by well-known techniques wherein an injection or compression molded core is covered by one or more intermediate layers or mantles and an outer cover by injection or compression molding. The various layers of a ball, (that is, the core, the mantle(s), and/or intermediate layers) are made by injection or compression molding a sphere or layer of desired size or thickness from the moisture resistant, high COR thermoplastic composition of the present invention which is optionally filled with sufficient filler to provide a golf ball meeting the weight limits (45 grams) set by the PGA. The amount of filler employed in the core and/or mantle(s) can be varied from 0 to about 60 wt % depending on the size (thickness) of the components and the desired location of the weight in the ball, provided that the final ball meets the required weight limits. The filler can be used in the core and not in the mantle, in the mantle and not in the core, or in both. While not intending to be limiting as to possible combinations, this embodiment includes:
1. a core comprising the composition of the present invention with a mantle made of any composition known in the art,
2. a core comprising the composition of the present invention used in the two-piece core or three-piece center with a mantle made the composition of the present invention with or without filler adjusted to provide a golf ball of the desired weight,
3. a core made of any composition (including thermoset compositions such as polybutadiene rubber) with a mantle comprising the composition of the present invention with or without filler provided that the weight of the finished golf ball meets the required limit.
   Covers

Covers for golf balls comprising the moisture resistant, High COR Thermoplastic described above are included in the invention. The covers can be made by injection or compression molding the moisture resistant, High COR Thermoplastic described above (with or without filler, other components, and other thermoplastics including other ionomers) over a thermoplastic or thermoset core of a two-piece golf ball, over windings around a thermoplastic or thermoset center, or as the outer layer of a multi-layer golf ball.

One-Piece Golf Ball Preferred Embodiments

One-piece balls can be made by well-known injection or compression techniques. They will have a traditional dimple pattern and may be coated with a urethane lacquer or be painted for appearance purposes, but such a coating and/or painting will not affect the performance characteristics of the ball.

The one-piece ball of this invention is made by injection or compression molding a sphere of desired size from the moisture resistant, High COR Thermoplastic described above that is filled with sufficient filler to provide a golf ball meeting the weight limits (45 grams) set by the PGA. Preferably, enough filler is used so that the ball has a density 1.14 gm/cc.

Process for Making Moisture Resistant High COR Ionomer

The melt-processible, highly-neutralized acid copolymer ionomer of the present invention can be produced by:
(a) melt-blending ethylene α,β ethylenically unsaturated C₃₋₈ carboxylic acid copolymer(s) and/or ionomer(s) thereof that are not neutralized to the level that they have become intractable (not melt-processible) with one or more aliphatic, mono-functional, saturated or unsaturated organic acids having less than 36 carbon atoms or salts of the organic acids and, either concurrently or subsequently,
(b) adding a sufficient amount of a cation source to increase the level of neutralization all the acid moieties (including those in the acid copolymer and in the organic acid) to greater than 70%.

Preferably the aliphatic, mono-functional, saturated or unsaturated organic acids having less than 36 carbon atoms or salts of the organic acids are present in a range of about 5 to about 150 parts (alternatively, about 25 to about 100) per hundred parts (pph) by weight of the ethylene α,β ethylenically unsaturated C₃₋₈ carboxylic acid copolymer(s) and/or ionomer(s) thereof.

Neutralization of acid copolymers and organic acids in this manner (concurrently or subsequently) has been found to be the only way without the use of an inert diluent to neutralize the copolymer without loss of processibility or properties such as toughness and elongation to a level higher than that which would result in loss of melt processibility and properties for the ionomer alone. For example, an acid copolymer can be neutralized to greater than about 70%, preferably to greater than about 80%, preferably to greater than about 90%, or more preferably to about 100% neutralization without losing the melt processibility which occurs normally with acid copolymers when neutralized to greater than 90%. In addition, higher neutralization reduces the volatile content of the organic acids, which could cause deposit on the mold vent upon molding mixtures with lower neutralization.

The acid copolymer(s) or unmodified, melt-processible ionomer(s) can be melt-blended with the organic acid(s) or salt(s) is any manner known in the art. For example, a salt and pepper blend of the components can be made and the components can then be melt-blended in an extruder.

The still melt-processible, acid-copolymer/organic-acid-or-salt blend can be neutralized or further neutralized by methods known in the art. For example, a Werner & Pfleiderer twin screw extruder can be used to neutralize the acid copolymer and the organic acid at the same time.

A process to make highly-neutralized, melt-processible ionomer comprises the steps of
(a) Melt-blending (1) an ethylene α,β ethylenically unsaturated carboxylic acid copolymer and/or a melt-processible ionomer; and (2) sufficient non-volatile, non-migratory organic acid and/or salts of the organic acid, and
(b) Concurrently or subsequently adding sufficient cation source to neutralize greater than about 70% of all the acid moieties of the acid copolymer or ionomer thereof and the acid moieties of the non-volatile, non-migratory organic acid.

Preferably the non-volatile, non-migratory organic acid is present in a range of about 5 to about 150 (alternatively, about 25 to about 100) pph by weight of the ethylene α,β ethylenically unsaturated C₃₋₈ carboxylic acid copolymer(s) and/or ionomer(s) thereof.

Preferably, the amount of cation source is in excess of the amount that is required to neutralize >90% the acid moieties in the acid copolymer and/or ionomer thereof and, to the extent that the non-volatile, non-migratory organic acid contains acid moieties, the acid moieties of the non-volatile, non-migratory organic acid.

Preferably, the process employs an ethylene α,α ethylenically unsaturated carboxylic acid copolymer and/or a melt-processible ionomer thereof that is an E/X/Y copolymer or melt-processible ionomer of the E/X/Y copolymer where E is ethylene, X is a C₃ to C₈ α,β ethylenically unsaturated carboxylic acid, and Y is a softening comonomer wherein X is about 4-25 wt % of the E/X/Y copolymer and Y is about 0-40 wt % of the E/X/Y copolymer.

Preferably the non-volatile, non-migratory agent is an organic acid and/or salt such as stearic acid, oleic acid, erucic acid, or behenic acid.

Thermoplastic, Moisture Resistant, Highly Resilient Ionomer

The resulting thermoplastic composition of this invention consists essentially of (a) aliphatic, mono-functional organic acid(s) having fewer than 36 carbon atoms; and (b) ethylene, C₃ to C₈ α,β ethylenically unsaturated carboxylic acid copolymer(s) and/or ionomer(s) thereof, wherein greater than 70%, 80%, 90%, preferably near 100%, and more preferably 100% of all the acid of (a) and (b) are neutralized, where at least 50% of the neutralizing cations are Zn, Ca, or a mixture thereof.

This resulting highly neutralized; melt-processible acid copolymer of this invention can be melt-blended with other components to produce end products. For example, it may be melt-blended with components employed in co-pending U.S. application Ser. No. 09/422,142 to make one-, two-, three-piece, and multi-layered golf balls and foamed materials useful in footwear and other sport balls such as softballs. The components used with the resulting highly neutralized, melt-processible acid copolymer in this case include thermoplastic polymer components selected from polyether-esters, polyether-amides, polyether-urea, elastomeric polyolefins, styrene diene block copolymers, thermoplastic polyurethanes, polyamide, polyester, polyolefins, ethylene copolymers, functionalized polymers with epoxy functionality or anhydride functionality, EPDM, mPE, ground up thermoset rubber, etc.; and fillers.

In another embodiment, blends of fatty acid modified copolymers can be suitable for use in the practice of the present invention. For example, blends suitable for the purposes described in the present application can be obtained by combining individual fatty acid-modified copolymers obtained as described herein, each individually suitable for use in the practice of the present invention, to obtain a copolymer blend of the present invention. Alternatively, blends of the acid copolymers or unmodified ionomers can be modified by addition of fatty acid as described herein. Alternatively, it may be desirable to blend an acid copolymer or unmodified ionomer with a modified copolymer or copolymer blend of the present invention. Still alternatively, a blend of the present invention may be obtained using components that individually do not have the properties described herein, but result in a blend suitable for the practice of the present invention. Blends of the present invention are not limited to two-component blends, and may be blends of up to 5 different copolymer components. Preferably the blends include 2 or 3 different copolymer components, and most preferably 2 different copolymer components.

Testing Criteria for Examples

Coefficient of Restitution (COR) is measured by firing an injection-molded neat sphere of the resin having the size of a golf ball from an air cannon at a velocity determined by the air pressure. The initial velocity generally employed is 125 feet/second. The sphere strikes a steel plate positioned three feet away from the point where initial velocity is determined, and rebounds through a speed-monitoring device located at the same point as the initial velocity measurement. The return velocity divided by the initial velocity is the COR.

PGA Compression is defined as the resistance to deformation of a golf ball, measured using an Atti machine.

Water vapor transmission rate (WVTR) is measured by converting the composition of this invention into a 1 mil film and measure the water vapor transmission rate using the MOCON Permatran-W700 test equipment at 37.8 deg. C under 100% RH. Thicker or thinner films could be used in the measurement and the resulting water vapor transmission rate should be normalized to 1 mil by dividing the test result by the film thickness in mil.

Tensile properties (tensile at break, elongation at break, tensile yield, and elongation yield) are determined in accord with ASTM D1708. This paragraph should be removed since we do not have tensile property to report.

Percent rebound is determined by dropping the ball (or three-piece center/two-piece core) from a height of 100 inches and measuring the rebound from a hard, rigid surface such as a thick steel plate or a stone block. An acceptable result is about 65-85%. Remove. Do not have rebound data.

### EXAMPLES

### Example 1

Employing a Werner & Pfleiderer twin screw extruder, a blend (Blend 1) of 95.3 wt % calcium stearate (CaSt)/4.7 wt % Ca(OH)₂ was melt blended with an ethylene acid copolymer (R1) (15% methacrylic acid/56 mol % neutralized with magnesium, 0.75 melt index (Ml)) at a feed ratio of 41.4 Blend 1 to 58.8 R1 in the extruder to produce a blend (Blend 2) comprising 76.4% calcium relative to the total cation present in the blend. Blend 2 was exposed to an atmosphere having a relative humidity of 50% and the weight gain from moisture pick-up was determined after 30 days. The results are reported in Table 1.

### Comparative Example C1

The procedure of Example 1 was repeated except that magnesium stearate (MgSt)/Mg(OH)₂ was used instead of CaSt/Ca(OH)₂. MgSt/Mg(OH)₂ blend ratio was 96.3 to 3.7. The MgSt and Mg(OH)₂ pre-blend was then fed with R1 at 40.9 to 50.1 feed ratio to prepare the blended product (Blend 3). Blend 3 was exposed to a humid environment as described in Example 1, and the results reported in Table 1.

### Comparative Example C2

Potassium stearate (KSt) was melt blended with an ethylene acid copolymer (R2) (15% methacrylic acid/59 mol % neutralized with sodium, Ml 0.93) as described in Example 1, at a feed ratio of 35 KSt:65 R2. The blend was exposed to a humid environment as described in Example 1, and the results reported in Table 1.

### Example 2

The procedure of Comparative Example C2 was repeated except that CaSt was used instead of KSt. The blend was exposed to a humid environment as described in Example 1, and the results reported in Table 1.

### Example 3

The procedure of Example 2 was repeated except that (1) the acid copolymer (R3) comprised 11 wt % methacrylic acid/57 mol % neutralized with Zn and an Ml of 5.2, and (2) CaSt was fed at a ratio of 30:70 rather than 35:65. The blend was exposed to a humid environment as described in Example 1, and the results reported in Table 1.

### Example 4

The procedure of Example 3 was repeated except that CaSt was fed in a ratio of 35:65 with R3. The blend was exposed to humid conditions as described in Example 1, and the results reported in Table 1.

### Example 5

The procedure of Example 4 was repeated except that CaSt was fed in a ratio of 40:60 with R3. The blend was exposed to humid conditions as described in Example 1, and the results reported in Table 1.

### Example 6

The procedure of Example 1 was repeated except that (1) 54.2% the acid copolymer (R4) comprised 15.5 wt % n-butyl acrylate/10.5% wt % acrylic acid and an Ml of 60, and (2) 35.8% Oleic acid and 9.95% ZnO were blended and in-situ neutralized. The blend (Blend 6) was exposed to humid conditions as described in Example 1, and the results reported in Table 1.

### Example 7

A blend was prepared based on 70 wt % of Blend 6 and 30 wt % Comparative example C4 and melt blended in a twin screw extruder. The blend was exposed to a humid environment as described in is Example 1, and the results reported in Table 1.

### Example 8

The procedure of Example 7 was repeated except that the blend ratio between Blend 6 and C4 was 60:40. The blend was exposed to a humid environment as described in Example 1, and the results reported in Table 1.

### Example 9

The procedure of Example 7 was repeated except that Blend 6 and C4 were blended at a feed ratio of 50:50. The blend was exposed to a humid environment as described in Example 1, and the results reported in Table 1.

### Comparative Example C3

The procedure of Example 7 was repeated except that Blend 6 and C4 were blended at a feed ratio of 30:70. The blend was exposed to a humid environment as described in Example 1, and the results reported in Table 1.

### Comparative Example C4

A single screw extrusion neutralization process was employed to melt blend and in-situ neutralize 52.8 wt % R4, 35% oleic acid, and 12.2% Mg(OH)₂ concentrate (50% loading of Mg(OH)₂ in a carrier resin) into the blended product. The blend was exposed to conditions of humidity as described in Example 1. The results are shown in Table 1.

TABLE 1

| | | | | | Moisture wt | Moisture wt |
|---|---|---|---|---|---|---|
| | Ca + Zn salt | ATTI | | | gain @ 30 | gain @ 61 |
| Ex. | (equivalent %) | Comp. | Hardness, D | COR-125 | days (%) | days (%) |
| 1 | 76.4 | 126 | 57 | 0.789 | 0.65 | |
| C1 | 0 | — | — | — | 1.69 | |
| C2 | 0 | — | — | — | 1.36 | — |
| 2 | 63.3 | 146 | 62.1 | 0.775 | 0.44 | 0.67 |
| 3 | 66.0 | 145 | 62.4 | 0.767 | 0.40 | 0.60 |
| 4 | 70.9 | 156 | 62.10.761 | 0.40 | 0.54 | 29 |
| 5 | 75.1 | 158 | 64.5 | 0.758 | 0.41 | 0.56 |
| 6 | 100.0 | 106 | 44.2 | 0.756 | 0.39 | 0.46 |
| 7 | 79.2 | 89 | 46 | 0.815 | 0.73 | 0.96 |
| 8 | 71.0 | 99 | 49.3 | 0.82 | 0.92 | 1.24 |
| 9 | 62.0 | 103 | 49.2 | 0.825 | 1.13 | 1.56 |
| C3 | 41.1 | 97 | 51.3 | 0.824 | 1.38 | 1.98 |
| C4 | 0 | 88 | 50.2 | 0.858 | 1.86 | 3.83 |

Thermoplastic Spheres

The following examples describe the preparation of blends for spheres for testing. Extrusion conditions for making blends identified in Table 1 are shown in Table 2.

TABLE 2
Extrusion Conditions for Making Blends (Table 5)

| Screw Speed | Zone 1 | Zone 2-3 | Zone 4-9 | Die | Rate | Vac. |
|---|---|---|---|---|---|---|
| Rpm | Temp ° C. | Temp ° C. | Temp ° C. | Temp ° C. | lb./hr | inches |
| 100-300 | 75-140 | 90-160 | 140-240 | 200-230 | 10-30 | 28 |

Molding conditions for making spheres that are 1.53 inches in diameter are shown in Table 3.

TABLE 3
Molding Conditions for Spheres

| | Temp. ° C. |
|---|---|
| Rear | 183 |
| Center | 173 |
| Front | 173 |
| Nozzle | 177 |
| Mold Front/Back | 10 |
| Melt | 195 |
| | Pressures Kg/cm² |
| Injection 1st Stage | 130 |
| Injection 2nd Stage | 110 |
| Injection Hold | 13 |
| | Cycle Times (sec) |
| Pack | 10 |
| Hold | 480 |
| Booster | 10 |
| Cure Time | 15 |
| Screw Retraction | 5.35 |

The results show values significantly higher than 0.740 in COR. These resins can be filled with dense fillers such as zinc oxide or BaSO₄, and/or blended with thermoplastic polymers, such as polyether-esters, polyether-amides, polyether-urea, elastomeric polyolefins, styrene diene block copolymers, thermoplastic polyurethanes, polyamide, polyester, polyolefins, ethylene copolymers, functionalized polymers with epoxy functionality or anhydride functionality, EPDM, mPE, ground up thermoset rubber, etc., to give thermoplastic golf ball parts.

1. A thermoplastic composition comprising (a) at least one aliphatic, mono-functional organic acid having fewer than 36 carbon atoms; and (b) ethylene, C₃ to C₈ α,β ethylenically unsaturated carboxylic acid copolymer(s) and/or ionomer(s) thereof, wherein greater than 70 mol % of all the acid of (a) and (b) are neutralized to salts and wherein at least about 50 equivalent % of the acid salts comprise Zn and/or Ca counterions.

2. The composition of claim 1 wherein at least about 60 equivalent % of the acid salts comprise Zn and/or Ca counterions.

3. The composition of claim 2 wherein at least about 70 equivalent % of the acid salts comprise Zn and/or Ca counterions.

4. The composition of claim 3 wherein at least about 80 equivalent % of the acid salts comprise Zn and/or Ca counterions.

5. The composition of claim 4 wherein at least about 90 equivalent % of the acid salts comprise Zn and/or Ca counterions.

6. A golf ball comprising at least one structural component obtained from a thermoplastic composition comprising (a) at least one aliphatic, mono-functional organic acid having fewer than 36 carbon atoms; and (b) at least one ethylene/C₃ to C₈ α,β ethylenically unsaturated carboxylic acid copolymer and/or ionomer thereof, wherein greater than 70 mol % of all the acid of (a) and (b) are neutralized to salts and wherein at least about 50 mol % of the acid salts comprise Zn and/or Ca counterions.

7. The golf ball of claim 6 wherein the COR is at least about 0.740, wherein the COR is measured by molding the thermoplastic composition into a sphere having a diameter of from 1.50 to 1.54 inches and firing the sphere at an initial velocity of 125 feet/second against a steel plate positioned 3 feet from a point where the initial velocity is determined, measuring a rebound velocity from the steel plate, and dividing the rebound velocity by the initial velocity.

8. The golf ball of claim 7 wherein the COR is in the range of from about 0.740 to about 0.875.

9. The golf ball of claim 8 wherein the COR is in the range of from about 0.740 to about 0.850.

10. The golf ball of claim 8 wherein X is from about 3 to about 30 wt % of the E/X/Y copolymer and Y is from about 0 wt % to about 40 wt % of the E/X/Y copolymer.

11. The golf ball of claim 10 wherein X is from about 5 to about 20 wt % of the E/XIY copolymer and Y is from about 10 to about 35 wt % of the E/X/Y copolymer.

12. The golf ball of claim 11 wherein the at least one structural component has a MVTR of less than about 80.

13. The golf ball of claim 12 wherein greater than about 80% of the acid in (a) and (b) is neutralized.

14. The golf ball of claim 13 wherein greater than about 90% of the acid in (a) and (b) is used to neutralize the acid in (a) and (b).

15. The golf ball of claim 14 wherein the organic acid is one or more C₆ to C₃₄ organic acids.

16. The golf ball of claim 15 wherein the organic acid is one or more C₆ to C₂₂ organic acids.

17. The golf ball of claim 16 wherein the organic acid is one or more of C₁₂ to C₁₈ organic acids.

18. The golf ball of claim 16 having an Atti compression of no more than 100.

19. The golf ball of claim 6 wherein the at least one structural layer is a cover.

20. The golf ball of claim 19 wherein at least one additional structural layer comprises the thermoplastic composition.

21. The golf ball of claim 6 wherein the at least one structural layer is an intermediate layer.

22. The golf ball of claim 21 wherein at least one additional structural layer comprises the thermoplastic composition.

23. The golf ball of claim 6 wherein the at least one structural layer is a core or a center.

24. The golf ball of claim 23 wherein at least one additional structural layer comprises the thermoplastic composition.

25. The golf ball of claim 6 wherein the ball comprises at least three structural layers comprising the thermoplastic composition.

26. The golf ball of claim 6 wherein the cover comprises a composition selected from polymers in the group consisting of: thermoset or thermoplastic polyurethanes; polyether-amides; polyether-esters; polyether-ureas; styrene/butadiene/styrene block copolymers; ionomers; and/or blends thereof.

27. A process for producing a composition suitable for use in a golf ball as a moisture resistant structural layer comprising the steps of: (1) blending at least one ethylene/C₃ to C₈ α,β ethylenically unsaturated carboxylic acid copolymer and/or ionomer thereof with an organic acid having fewer than 36 carbons atoms; and (2) neutralizing at least 70% of the acid functional groups present in the blend to salts, wherein at least about 50 mol % of the salts have calcium (Ca) and/or zinc (Zn) counterions.

28. The process of claim 27 wherein at least about 60 mol % of the counterions are Ca and/or Zn.

29. The process of claim 28 wherein at least about 70 mol % of the counterions are Ca and/or Zn.

30. The process of claim 29 wherein at least about 80 mol % of the counterions are Ca and/or Zn.

31. The process of claim 30 wherein at least about 90 mol % of the counterions are Ca and/or Zn.

32. A process for manufacturing a golf ball comprising the step of: including at least one moisture resistant structural layer comprising a thermoplastic composition comprising (a) at least one aliphatic, mono-functional organic acid having fewer than 36 carbon atoms; and (b) at least one ethylene/C₃ to C₈ α,β ethylenically unsaturated carboxylic acid copolymer and/or ionomer thereof, wherein greater than 70 mol % of all the acid of (a) and (b) are neutralized to salts and wherein at least about 50 mol % of the acid salts comprise Zn and/or Ca counterions.
